(19) United States
(12) Patent Application Publication
(10) Pub. No.: US 2024/0315922 A1
(43) Pub. Date: Sep. 26, 2024

(54) BATHTUB

(71) Applicant: Kohler (China) Investment Co., Ltd, Shanghai (CN)

(72) Inventors: Weimin ZHANG, Shanghai (CN); Jason KWACZ, Shanghai (CN)

(73) Assignee: Kohler (China) Investment Co., Ltd, Shanghai (CN)

(21) Appl. No.: 18/610,518

(22) Filed: Mar. 20, 2024

(30) Foreign Application Priority Data
Mar. 22, 2023 (CN) 202320583907.X

(51) Int. Cl. A61H 33/02

(52) U.S. Cl. CPC A61H 33/028

(57) ABSTRACT

A bathtub comprises a bathtub body, a water pump mounted on an outer side of a bathtub body side plate of the bathtub body, and a bubble water generating device mounted on the bathtub body side plate. The bathtub body side plate is provided with a side plate water outlet hole. A first water pipe is connected between the side plate water outlet hole and a water inlet of the water pump. A second water pipe is connected between a water outlet of the water pump and the bubble water generating device. A device water inlet in communication with the mixing flow channel is provided at one end of the device main body. A radius of the device water inlet is greater than a radius of the mixing flow channel.

### CROSS-REFERENCE TO RELATED PATENT APPLICATIONS

This application claims the benefit of priority to Chinese Utility Model patent application Ser. No. 202320583907.X, filed Mar. 22, 2023, the entirety of which is incorporated herein by reference.

### BACKGROUND

The application relates to the technical field of bathroom device, particularly to a bathtub. A bathtub is a sanitary product that is mounted in the bathroom for the user to take a bath or shower. A common bathtub generally uses usual tap water. With the development of people's life, the performance requirements for products are also getting higher and higher, some bathtubs begin to mount a micro bubble generating device, the micro bubble water has a good cleaning effect on the human body and has a sterilizing effect.

The technical solution of the above patent requires an air pump to supply air, which is costly and needs to a install fixedly the air pump specially. The structure is complex and has a large size. The entire micro-nano bubble generating device is mounted at a bottom of the bathtub body, making it inconvenient to disassemble, maintain and replace.

### SUMMARY

One embodiment relates to a bathtub with a micro-nano bubble generating device. The bathtub comprises a bathtub body, a water pump, an air pump and a bubble generating nozzle. An outlet end of the bubble generating nozzle is threadedly connected with an inlet end of an aeration plate. A water inlet end of the bubble generating nozzle is connected with an outlet end of a water filter through a water inlet pipe. The water pump is mounted on the water inlet pipe. An air inlet end of the bubble generating nozzle is connected with an outlet end of the air pump through an air inlet pipe, and the air inlet pipe is mounted with a one-way valve. The air pump and the water pump are electrically connected with a controller.

The application aims to overcome the defects in the prior art and provides a new bathtub, wherein a bubble water generating device is mounted on a bathtub body side plate, a water pump is mounted on an outer side of the bathtub body side plate, which is easy to install, remove and maintain, the bubble water generating device adsorbs air into a mixing flow channel by negative pressure, so there is no need to specially configure an air pump, which simplifies the structure, reduces the size of the structure, and saves the cost.

A technical solution of the application provides a bathtub, which comprises a bathtub body, a water pump mounted on an outer side of a bathtub body side plate of the bathtub body, and a bubble water generating device mounted on the bathtub body side plate. The bathtub body side plate is provided with a side plate water outlet hole, a first water pipe is connected between the side plate water outlet hole and a water inlet of the water pump, and a second water pipe is connected between a water outlet of the water pump and the bubble water generating device. The bubble water generating device comprises a device main body having a mixing flow channel. The device air inlet hole in communication with the mixing flow channel is provided on a side portion of the device main body; and a device water inlet in communication with the mixing flow channel is provided at one end of the device main body, the radius of the device water inlet is greater than the radius of the mixing flow channel, and the second water pipe is connected with the device water inlet.

In some embodiments, two or more the device air inlet holes are provided at intervals on the side portion of the device main body. In some embodiments, the diameter of the device air inlet hole is less than or equal to 1 mm. In some embodiments, the device air inlet hole is a tapered hole, and the radius of the device air inlet hole gradually decreases along an air flow direction.

In some embodiments, the device air inlet hole is located near the end at which the device water inlet is located. In some embodiments, the device air inlet hole is arranged perpendicular to the mixing floe channel. In some embodiments, a flow channel outlet of the mixing flow channel is trumpet-shaped.

In some embodiments, a tapered transition hole is connected between a flow channel inlet of the mixing flow channel and the device water inlet, and the radius of the tapered transition hole gradually decreases along a water flow direction. In some embodiments, the side plate water outlet hole is located at a bottom of the bathtub body side plate. In some embodiments, a bracket is mounted on the outer side of the bathtub body side plate, and the water pump is mounted on the bracket.

By adopting the technical solutions above, the application has the following beneficial effects. According to the bathtub provided by the application, the water pump is mounted on the outer side of the bathtub body side plate, the bubble water generating device is mounted on the bathtub body side plate, which is easy to install, disassemble and maintain.

The radius of the device water inlet of the bubble water generating device is greater than the radius of the mixing flow channel, the device air inlet hole is located on the side portion of the device main body and in communication with the mixing flow channel. After water enters the mixing flow channel through the device water inlet hole, negative pressure can be generated in the device air inlet hole, and the device air inlet hole will suck the air into the mixing flow channel. The intake air is mixed and flows with the water, eventually forming a bubble water. The bubble water generating device adsorbs air into the mixing flow channel by negative pressure, so there is no need to specially configure an air pump, which simplifies the structure, reduces the size of the structure, and saves the cost.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a perspective view of a first view angle of a bathtub, according to an exemplary embodiment;

FIG. 2 is a perspective view of a second view angle of the bathtub of FIG. 1, according to an exemplary embodiment;

FIG. 3 is an exploded view of the bathtub of FIG. 1, according to an exemplary embodiment;

FIG. 4 is a cross-sectional view of a first structure of a bubble water generating device, according to an exemplary embodiment;

FIG. 5 is a cross-sectional view of a second structure of a bubble water generating device, according to an exemplary embodiment;

FIG. 6 is a cross-sectional view of a third structure of a bubble water generating device, according to an exemplary embodiment; and

FIG. 7 is a cross-sectional view of a fourth structure of a bubble water generating device, according to an exemplary embodiment.

### DETAILED DESCRIPTION

Before turning to the FIGURES, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

The specific embodiments of the application will be further described with reference to the drawings hereinafter. Same parts are denoted by same reference numerals. It should be noted that the terms “front”, “back”, “left”, “right”, “up” and “down” used in the following description refer to the directions in the drawings, and the terms “inner” and “outer” refer to the directions towards or far away from geometric centers of specific parts respectively.

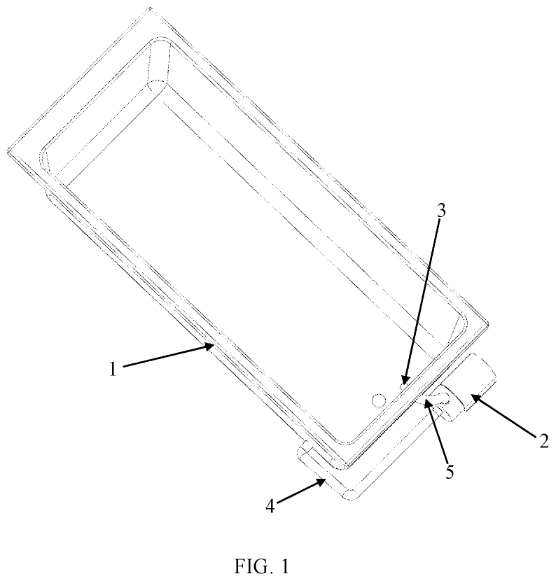

Referring generally to the FIGURES, an exemplary embodiment of a bathtub comprising a bathtub body, a water pump mounted on an outer side of a bathtub body side plate of the bathtub body, and a bubble water generating device mounted on the bathtub body side plate. As shown in FIGS. 1 to 4, the bathtub provided by an embodiment of the application comprises a bathtub body 1, a water pump 2 mounted on an outer side of a bathtub body side plate 12 of the bathtub body 1, and a bubble water generating device 3 mounted on the bathtub body side plate 12.

The bathtub body side plate 12 is provided with a side plate water outlet hole 121, a first water pipe 4 is connected between the side plate water outlet hole 121 and a water inlet of the water pump 2, and a second water pipe 5 is connected between a water outlet of the water pump 2 and the bubble water generating device 3.

In some embodiments, the bubble water generating device 3 comprises a device main body 31 having a mixing flow channel 311. A device air inlet hole 313 in communication with the mixing flow channel 311 is provided on a side portion of the device main body 31.

A device water inlet 312 in communication with the mixing flow channel 311 is provided at one end of the device main body 31, the radius of the device water inlet 312 is greater than the radius of the mixing flow channel 311, and the second water pipe 5 is connected with the device water inlet 312. The application provides the bathtub comprising the bathtub body 1, the water pump 2, the bubble water generating device 3, the first water pipe 4 and the second water pipe 5.

The bathtub 1 comprises a bathtub body bottom plate 11 and the bathtub body side plates 12 integrally provided around the bathtub body bottom plate 11, at least one of the bathtub body side plates 12 is provided with the side plate water outlet hole 121, and at least one of the bathtub body side plates 12 is provided with a side plate mounting hole.

The water pump 2 is mounted on the outer side of one bathtub body side plate 12, the bubble water generating device 3 is mounted in the side plate mounting hole of one bathtub body side plate 12, and a bubble water outlet end of the bubble water generating device 3 faces an inner side of the bathtub body side plate 12.

The first water pipe 4 is connected to the side plate water outlet hole 121 and connected with the water inlet of the water pump 2, and the second water pipe 5 is connected between the water outlet of the water pump 2 and a water inlet of the bubble water generating device 3.

When there is water in the bathtub body 1, the water pump 2 is turned on, the water enters the water pump 2 for pressurization through the first water pipe 4, and then enters the bubble water generating device 3 through the second water pipe 5, and the bubble water is generated by the bubble water generating device 3 and supplied into the bathtub body 1. The bubble water generating device 3 may generate microbubble water or nanoscale bubble water, which have a sterilizing function. For the sterilizing and cleaning function of the microbubble water or nanoscale bubble water, please refer to the description in the prior art, and it will not be elaborated herein.

The bubble water generating device 3 used in the application comprises the device main body 31, the device main body 31 may be a column body, and has the mixing flow channel 311 inside for mixing the air and water.

The device water inlet 312 is provided at one end of the device main body 31, the radius of the device water inlet 312 is greater than the radius of the mixing flow channel 311, and the second water pipe 5 is connected with the device water inlet 312. In some embodiments, at least one side of the device main body 31 is provided with the device air inlet hole 313, and the device air inlet hole 313 is in communication with the mixing flow channel 311.

After the water enters the mixing flow channel 311 through the device water inlet 312, because the bore diameter of the mixing flow channel 311 is smaller than the bore diameter of the device water inlet 312, the water is pressurized in the mixing flow channel 311, and the flow velocity increases, which causes the device air inlet hole 313 to form a negative pressure, and then the surrounding air is adsorbed and enters the mixing flow channel 311 to mix with water. The high-pressure water and air are mixed and flow along the narrow mixing flow channel 311 at high velocity, eventually forming bubble water.

To sum up, according to the bathtub provided by the application, the water pump 2 is mounted on the outer side of the bathtub body side plate 12, the bubble water generating device 3 is mounted on the bathtub body side plate 12, which is easy to install, disassemble and maintain.

The radius of the device water inlet 312 of the bubble water generating device 3 is greater than the radius of the mixing flow channel 311, the device air inlet hole 313 is located on the side portion of the device main body 31 and in communication with the mixing flow channel 311. After water enters the mixing flow channel 311 through the device water inlet 312, negative pressure will be generated in the device air inlet hole 313, and the device air inlet hole 313 will suck the air into the mixing flow channel. The intake air is mixed and flows with the water, eventually forming a bubble water. The bubble water generating device 3 uses the negative pressure to adsorb air into the mixing flow channel, so there is no need to specially configure an air pump, which simplifies the structure, reduces the size of the structure, and saves the cost.

In one of the embodiments, as shown in FIG. 5, two or more device air inlet holes 313 are provided at intervals on a side portion of the device main body 31, which can supply more air into the mixing flow channel 311 to increase the bubbles in the water.

In one of the embodiments, the diameter of the device air inlet hole 313 is less than or equal to 1 mm, and the air entering the mixing flow channel 311 is very thin, which facilitates the subsequent mixing with the high pressure water to form microbubble water or nanoscale bubble water.

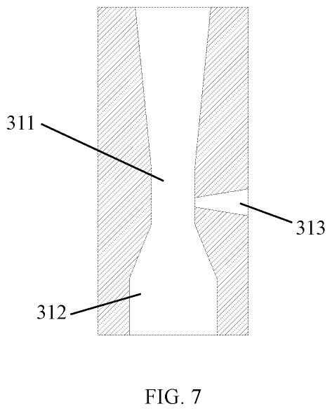

In one of the embodiments, the device air inlet hole 313 is a tapered hole, and the radius of the device air inlet hole 313 gradually becomes smaller along an air flow direction, as shown in FIG. 7.

In some embodiments, the device air inlet hole 313 is a tapered hole or a trumpet-shaped hole with a large opening at the air inlet end and a small opening at the air outlet end, so that when negative pressure is formed in the device air inlet hole 313, the surrounding air can be adsorbed through the air inlet end with the larger opening, which is beneficial for enhancing the intake effect.

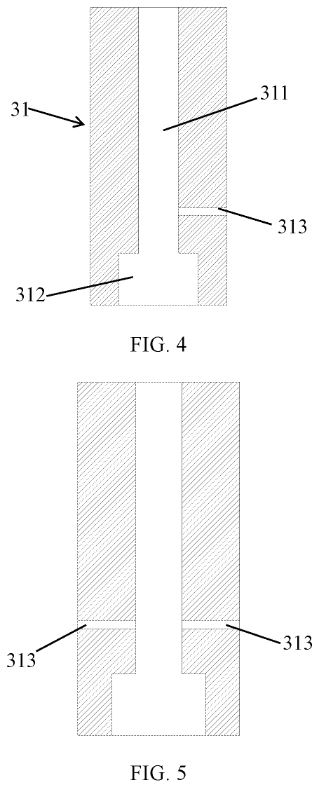

In some embodiments, as shown in FIGS. 4 to 7, the device air inlet hole 313 is located near the end at which the device water inlet 312 is located, so that the air and the water have a longer flow path in the narrow mixing flow channel 311, and sufficient mixing is carried out.

In some embodiments, as shown in FIGS. 4 to 7, the device air inlet hole 313 is arranged perpendicularly to the mixing flow channel 311, the air flowing into the mixing flow channel 311 is basically perpendicular to the flow direction of the water, and the air can be sucked into a deep position in the water, which is beneficial for air-liquid mixing.

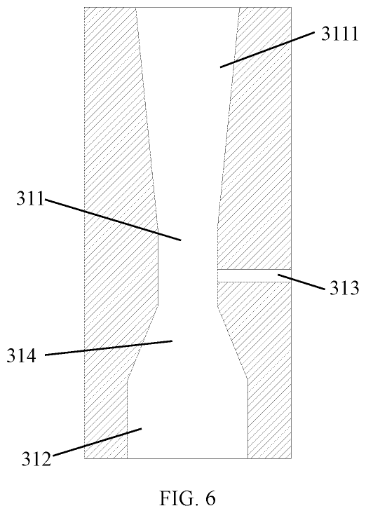

In some embodiments, as shown in FIGS. 6 to 7, a flow channel outlet 3111 of the mixing flow channel 311 is trumpet-shaped, which is beneficial for rapid discharging of the mixed air-liquid through the flow channel outlet 3111.

In some embodiments, as shown in FIGS. 6 to 7, a tapered transition hole 314 is connected between a flow channel inlet of the mixing flow channel 311 and the device water inlet 312, and the radius of the tapered transition hole 314 gradually becomes smaller along a water flow direction. It is advantageous to guide the high pressure water from the device water inlet 312 with a larger bore diameter into the mixing flow channel 311 with a smaller bore diameter through the tapered transition hole 314.

In some embodiments, as shown in FIG. 3, the side plate water outlet holes 121 are located at a bottom of the bathtub body side plate 12, such that the water pump 2 and the bubble water generating device 3 can be activated when the water level in the bathtub body 1 is low.

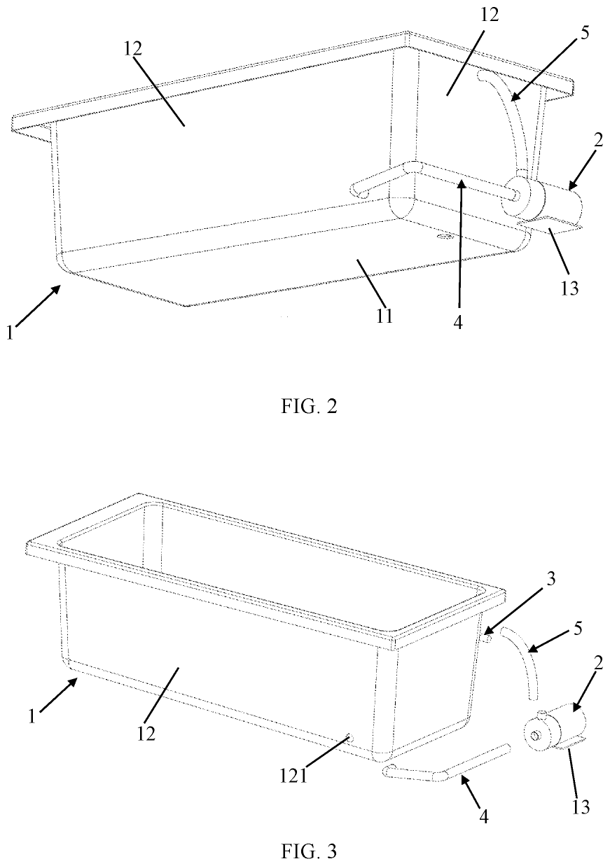

In some embodiments, as shown in FIGS. 2 to 3, a bracket 13 is mounted on the outer side of the bathtub body side plate 12, and the water pump 2 is mounted on the bracket 13.

The bracket 13 may be an L-shaped bracket plate, the bracket 13 is fastened to the outer side of the bathtub body side plate 12 by through a connecting member, and the water pump 2 is directly mounted on the main bracket 13 through bolts, screws and the like, which facilitates installing and fixing the water pump 2.

The above technical solutions may be combined as required to achieve the best technical effect.

The present disclosure provides a bathtub, wherein a bubble water generating device is mounted on a bathtub body side plate, a water pump is mounted on an outer side of the bathtub body side plate, which is easy to install, disassemble and maintain; the bubble water generating device uses the negative pressure to adsorb air into a mixing flow channel, so there is no need to specially configure an air pump, which simplifies the structure, reduces the size of the structure, and saves the cost.

The above are merely the principle and the preferred embodiments of the application. It should be pointed out that, for those of ordinary skills in the art, several other modifications may be made on the basis of the principle of the application, which should also be regarded as falling in the protection scope of the application.

As utilized herein with respect to numerical ranges, the terms “approximately,” “relative to,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “relative to,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure. In addition, the terms “first”, “second” and “third” are used for descriptive purposes only and are not to be construed as indicating or implying relative importance.

Although the figures and description may illustrate a specific order of method steps, the order of such steps may differ from what is depicted and described, unless specified differently above. Also, two or more steps may be performed concurrently or with partial concurrence, unless specified differently above.

What is claimed is:

1. A bathtub, comprising:
a bathtub body;
a water pump mounted on an outer side of a bathtub body side plate of the bathtub body; and
a bubble water generating device mounted on the bathtub body side plate,
wherein the bathtub body side plate is provided with a side plate water outlet hole, a first water pipe is connected between the side plate water outlet hole and a water inlet of the water pump, and a second water pipe is connected between a water outlet of the water pump and the bubble water generating device;
wherein the bubble water generating device comprises a device main body having a mixing flow channel;
wherein a device air inlet hole in communication with the mixing flow channel is provided on a side portion of the device main body;
wherein a device water inlet in communication with the mixing flow channel is provided at one end of the device main body, a radius of the device water inlet is greater than a radius of the mixing flow channel, and the second water pipe is connected with the device water inlet.

2. The bathtub according to claim 1, wherein two or more device air inlet holes are provided at intervals on the side portion of the device main body.

3. The bathtub according to claim 1, wherein a diameter of the device air inlet hole is less than or equal to 1 mm.

4. The bathtub according to claim 1, wherein the device air inlet hole is a tapered hole, and a radius of the device air inlet hole gradually decreases along an air flow direction.

5. The bathtub according to claim 1, wherein the device air inlet hole is located near the end at which the device water inlet is located.

6. The bathtub according to claim 1, wherein the device air inlet hole is arranged perpendicular to the mixing flow channel.

7. The bathtub according to claim 1, wherein a flow channel outlet of the mixing flow channel is trumpet-shaped.

8. The bathtub according to claim 1, wherein a tapered transition hole is connected between a flow channel inlet of the mixing flow channel and the device water inlet, and a radius of the tapered transition hole gradually decreases along a water flow direction.

9. The bathtub according to claim 1, wherein the side plate water outlet hole is located at a bottom of the bathtub body side plate.

10. The bathtub according to claim 1, wherein a bracket is mounted on the outer side of the bathtub body side plate, and the water pump is mounted on the bracket.

11. A bathtub, comprising:
a bathtub body;
a water pump mounted on an outer side of a bathtub body side plate of the bathtub body; and
a bubble water generating device mounted on the bathtub body side plate,
wherein the bathtub body side plate is provided with a side plate water outlet hole, a first water pipe is connected between the side plate water outlet hole and a water inlet of the water pump, and a second water pipe is connected between a water outlet of the water pump and the bubble water generating device;
the bubble water generating device further comprises a device main body having a mixing flow channel, the mixing flow channel is in communication with a device air inlet hole that is provided on a side portion of the device main body;
the main body further comprises a device water inlet in communication with the mixing flow channel is provided at one end.

12. The bathtub of claim 11, wherein a radius of the device water inlet is greater than a radius of the mixing flow channel, and the second water pipe is connected with the device water inlet.

13. The bathtub according to claim 11, wherein two or more device air inlet holes are provided at intervals on the side portion of the device main body.

14. The bathtub according to claim 11, wherein a diameter of the device air inlet hole is less than or equal to 1 mm.

15. The bathtub according to claim 11, wherein the device air inlet hole is a tapered hole, and a radius of the device air inlet hole gradually decreases along an air flow direction.

16. The bathtub according to claim 11, wherein the device air inlet hole is located near the end at which the device water inlet is located.

17. The bathtub according to claim 11, wherein the device air inlet hole is arranged perpendicular to the mixing flow channel.

18. The bathtub according to claim 11, wherein a flow channel outlet of the mixing flow channel is trumpet-shaped.

19. The bathtub according to claim 11, wherein a tapered transition hole is connected between a flow channel inlet of the mixing flow channel and the device water inlet, and a radius of the tapered transition hole gradually decreases along a water flow direction.

20. The bathtub according to claim 11, wherein the side plate water outlet hole is located at a bottom of the bathtub body side plate.
